(19) United States
(12) Patent Application Publication
(10) Pub. No.: US 2007/0222594 A1
(43) Pub. Date: Sep. 27, 2007

(54) Removable pocketbook or handbag electronic alarmed liner

(76) Inventor: Dorothy P. Kohn, Cheltenham, PA (US)

Correspondence Address: DOROTHY P. KOHN, 108 KREWSON LANE, CHELTENHAM, PA, 19012, US

(21) Appl. No.: 11/377,660

(22) Filed: Mar. 14, 2006

(51) Int. Cl. G08B 13/14

(52) U.S. Cl. 340/568.7

(57) ABSTRACT

A removable liner can be inserted in a women's handbag or mans briefcase. This liner contains a removable packaged device that consists of a compilation of a radio controlled sonic alarm receiver, with a crystal controlled radio frequency hand receiver that is tuned to a small matched frequency radio transmitter, that is carried on the person. A stable adjusted zone of signal influence will be providing a zone of 20 feet around the person. When the pocketbook or briefcase is removed, stolen or mislaid or is removed from the zone of influence within 10 feet of the radio controlled receiver a loud sonic alarm and/or vibration will alert the owner and security guards of the distress of the device protected handbag or briefcase.

In cross-reference to related application this invention is an improvement over my previous patent No. Des. 334,661.

### BACKGROUND OF THE INVENTION

In cross-reference to related application this invention is an improvement over my previous patent No. Des. 334,661, as it adds theft protection. The lining of a handbag is not removable, the D. patent is, because it is a separate liner designed to enable you to have the convenience of a quick change to another color texture or design handbag, and therefore you can remove the liner with all its contents and insert it into another handbag compatible with this liner. The outer look can be entirely different, however to utilize the liner the opening must be the same. The improvement is a theft protection device, which now becomes a removable sonic alarmed liner that you personally control the on and off feature, made from a compilation of radio devices, remote crystal controlled radio frequency hand receiver that is tuned to a small matched frequency radio transmitter, which when removed from the zone of controlled influence, a sonic alarm and or vibration will sound an alarm and you will know your handbag has moved. This is a big improvement over the Prior Art U.S. Pat. No. 3,958,616 May 25, 1976 Jean E. Beverstock As you do not have to have the chain on your hand to know it is being stolen and experience the irritant of the gas of the explosive sound. On paragraph 5 on page 5 summaries.

### BRIEF SUMMARY OF INVENTION

Women have had to live with the inconvenience of having to transfer the contents of a handbag or purse to fit the occasion, during this transfer from one handbag to another, needed items are inevitably and inadvertently misplaced, lost or left in the previous handbag. This invention has a removable separate liner and is a quick change to transfer the contents in the liner in tacked to another handbag of different color or style or fabric that is compatible with the opening of the liner, attaching to the inside of the hand bag by Velcro, snaps or zipper which solves the problem and is desperately needed. The utility patent improvement of the removable liner is also a needed addition as it offers theft protection because it has a removable sonic alarm and or vibration to alert the carrier, which could also be a man, as recent news state more men are using handbags and cases. It is not possible to constantly hold on to your handbag and at times you may put down your purse and at time is when theft can occur.

The moment the handbag FIG. B is removed from radio frequency zone of influence FIG. A of 10 feet The sonic alarm is activated, to alert owner or security guards of a distress condition of the handbag being stolen or mislaid. The compilation of radio devices used are of common knowledge to a patented examiner, but the use of zone field of influence and location of a sage area for a lady or man's handbag related A zone of Radio Frequency protection device, is claim to a patent

The sonic alarm is activated to alert owner and proper authorities of an incident of theft or loss, as it is occurring. Any one who has previously considered the effects of the loss of their identity or had lost it, at one time, would appreciate this option.

### BRIEF DESCRIPTION OF THE SEVERAL VIEWS OF THE DRAWINGS

FIG. 1 is a perspective view of a removable pocketbook liner showing my new design with a pocketbook showed in phantom lines in exploded relationship for purposes of association, with a removable sonic alarm attached with a chain or Velcro or placed in a pocket shown in FIG. 1

FIG. 2 is a front elevational view thereof, it shows that it can be attached to the handbag, by means of choices of Velcro Zipper or Snaps.

FIG. 3 is a rear elevational view thereof;

FIG. 4 is a right side elevational view thereof,

FIG. 5 is a left side elevational view thereof;

FIG. 6 is a top plan view thereof; and

FIG. 7 is a bottom plan view thereof;

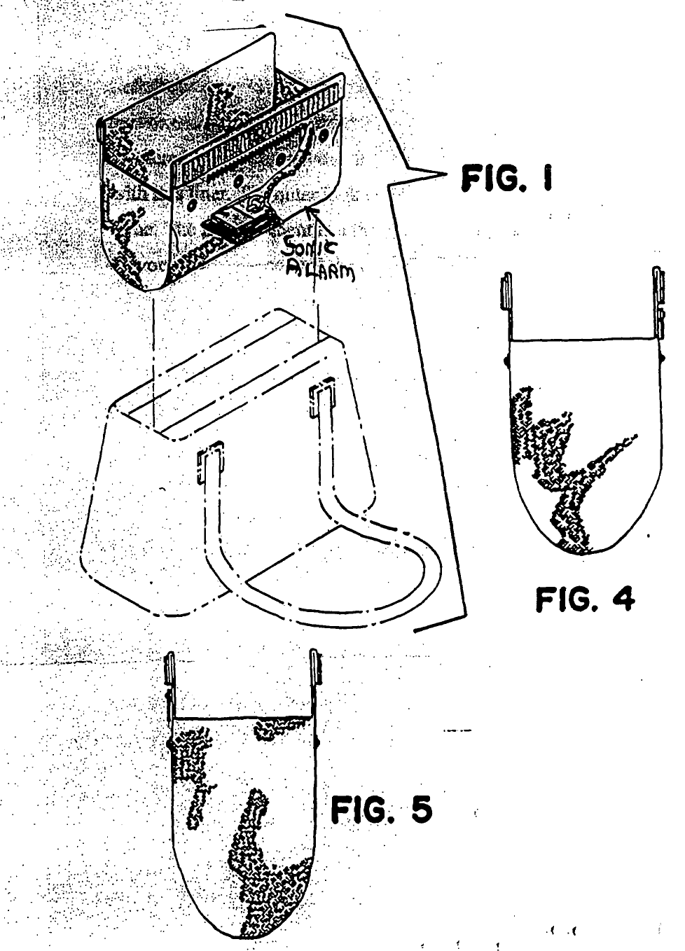

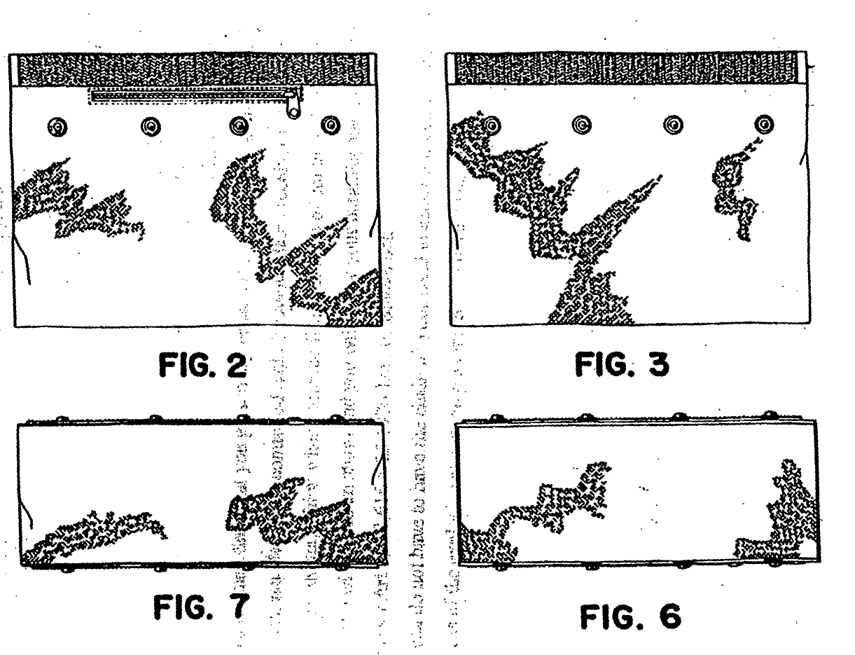

The broken line showing of a pocketbook in FIG. 1 is for illustrative purposes only and forms no part of the claimed design.

1. A alarm device inserted in a ladies or man's removable handbag, or pocketbook liner protecting theft or loss in shopping malls and stores causing the loss of valuable contents including cash credit cards, checkbooks, id's etc.

2. The removable liner also allows an easy and quick change of contents to another style or color of a handbag compatible, to accept the liner while offering theft protection at the same time.

3. To achieve the above protection there is a signal device FIG. A, which is a remote radio transmitter signal A with a small tuned effective zone of influence for FIG. B controlled sonic alarm, that alerts the owner of its theft as it occurs.
